(19) United States
(12) Patent Application Publication
(10) Pub. No.: US 2026/0299226 A1
(43) Pub. Date: Oct. 1, 2026

(54) FIBER OPTIC CABLE STRUCTURE INCLUDING FOLDABLE FIBER OPTIC CABLE WITH COUPLER THEREFOR AND RELATED METHOD

(71) Applicant: GlobalFoundries U.S. Inc., Malta, NY (US)

(72) Inventor: Jae Hoon Kim, Cary, NC (US)

(21) Appl. No.: 19/095,224

(22) Filed: Mar. 31, 2025

(51) Int. Cl. G02B 6/42; G02B 6/36

(52) U.S. Cl. CPC G02B 6/424; G02B 6/3616; G02B 6/3636; G02B 6/4239; G02B 6/426

(57) ABSTRACT

A fiber cable structure includes a foldable fiber optic cable having a first end and a second end. The first end is fixed relative to a cable mount of a photonics integrated circuit (PIC) die module. An optical connector is on the second end of the foldable fiber optic cable to couple fibers of the foldable fiber optic cable to an optical device. A cable positioner is fixed relative to the cable mount. A coupler couples the optical connector to the cable positioner with the foldable fiber optic cable including at least one fold therein. A PIC die module and a related method are also disclosed.

### BACKGROUND

The present disclosure relates to photonic system connections and, more particularly, to a fiber optic cable structure including a foldable fiber optic cable with a coupler for use with, for example, a photonic integrated circuit (PIC) die module, and a related method.

Silicon photonics combine integrated circuits with optical systems. A photonics integrated circuit (PIC) die module includes an integrated circuit coupled to an outside optical device or network by a fiber optic cable. The fiber optic cable extends away from the PIC die module and includes a connector for connecting the PIC die module to an outside optical device or network. The PIC die module undergoes several processes after the fiber optic cable is coupled thereto, such as inspection, testing and mounting of the PIC die module on another (mother) circuit board. Handling of the PIC die module with the fiber optic cable attached thereto can be challenging due to the potential size differences between the PIC die module and the fiber optic cable. In addition, handling the PIC die module is challenging due to the relatively long length of the fiber optic cable, e.g., twenty (20) or more centimeters. In certain cases, the PIC die module may include more than one fiber optic cable coupled to it, which further complicates handling.

### SUMMARY

All aspects, examples and features mentioned below can be combined in any technically possible way.

An aspect of the disclosure provides a fiber cable structure, comprising: a foldable fiber optic cable having a first end and a second end, wherein the first end is fixed relative to a cable mount of a photonics integrated circuit (PIC) die module; an optical connector on the second end of the foldable fiber optic cable to couple fibers of the foldable fiber optic cable to an optical device; a cable positioner fixed relative to the cable mount; and a coupler operable to couple the optical connector to the cable positioner with the foldable fiber optic cable including at least one fold therein.

An aspect of the disclosure provides a photonics integrated circuit (PIC) die module, comprising: a substrate; a PIC die on the substrate; and at least one of the following: a foldable fiber optic cable having a first end and a second end, wherein the first end is fixed relative to a cable mount of a photonics integrated circuit (PIC) die module; an optical connector on the second end of the foldable fiber optic cable to couple fibers of the foldable fiber optic cable to an optical device; a cable positioner fixed relative to the cable mount; and a coupler operable to couple the optical connector to the cable positioner with the foldable fiber optic cable including at least one fold therein.

An aspect of the disclosure provides a method, comprising: coupling a first end of a foldable fiber optic cable having the first end and a second end to a cable mount of a photonics integrated circuit (PIC) die module, wherein the foldable fiber optic cable includes an optical connector on the second end of the foldable fiber optic cable configured to couple fibers of the foldable fiber optic cable to an optical device; fixing a cable positioner relative to the cable mount; forming at least one fold in the foldable fiber optic cable; and coupling the optical connector to the cable positioner using a coupler including a first coupling element fixed relative to one of the cable positioner and the optical connector and a second coupling element fixed relative to the other of the cable positioner and the optical connector, wherein the first and second coupling elements are configured to couple together.

Two or more aspects described in this disclosure, including those described in this summary section, may be combined to form implementations not specifically described herein. The details of one or more implementations are set forth in the accompanying drawings and the description below. Other features, objects and advantages will be apparent from the description and drawings, and from the claims.

### BRIEF DESCRIPTION OF THE DRAWINGS

The embodiments of this disclosure will be described in detail, with reference to the following figures, wherein like designations denote like elements, and wherein:

FIG. 1 shows a top-down view of a fiber cable structure according to embodiments of the disclosure;

FIG. 2 shows a side view of a fiber cable structure according to embodiments of the disclosure;

FIG. 3 shows a top-down view of an optical connector of a fiber cable structure coupled to a cable positioner with a foldable fiber optic cable including at least one fold therein according to embodiments of the disclosure;

FIG. 4 shows a side view of an optical connector of a fiber cable structure coupled to a cable positioner with a foldable fiber optic cable including at least one fold therein according to embodiments of the disclosure;

FIG. 5 shows a side view of an optical connector of a fiber cable structure coupled to a cable positioner with a foldable fiber optic cable including more than one fold according to embodiments of the disclosure;

FIGS. 6A-C show a top-down view, a side view and an end view of parts of a coupler, a cable positioner and/or an optical connector, respectively, according to embodiments of the disclosure;

FIGS. 7A-C show a top-down view, a side view and an end view of parts of a coupler, a cable positioner and/or an optical connector, respectively, in a reverse arrangement of coupling elements as in FIGS. 6A-C according to other embodiments of the disclosure;

FIGS. 8A-C show a top-down view, a side view and an end view of parts of a coupler, a cable positioner and/or an optical connector, respectively, according to other embodiments of the disclosure;

FIGS. 9A-C show a top-down view, a side view and an end view of parts of a coupler, a cable positioner and/or an optical connector, respectively, in a reverse arrangement from that shown in FIGS. 8A-C according to other embodiments of the disclosure;

FIGS. 10A-C show a top-down view, a side view and an end view of parts of a coupler, a cable positioner and/or an optical connector, respectively, according to yet other embodiments of the disclosure;

FIGS. 11A-C show a top-down view, a side view and an end view of parts of a coupler, a cable positioner and/or an optical connector, respectively, in a different arrangement from that shown in FIGS. 10A-C according to other embodiments of the disclosure;

FIG. 12 shows an end view of parts of a coupler, a cable positioner and/or an optical connector, respectively, according to additional embodiments of the disclosure;

FIG. 13 shows a top-down view of a PIC die module including more than one fiber cable structure according to embodiments of the disclosure;

FIG. 14 shows a top-down view of a PIC die module including more than one fiber cable structure according to embodiments of the disclosure; and

FIG. 15 shows a flow diagram of a method according to embodiments of the disclosure.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION

In the following description, reference is made to the accompanying drawings that form a part thereof, and in which is shown by way of illustration specific illustrative embodiments in which the present teachings may be practiced. These embodiments are described in sufficient detail to enable those skilled in the art to practice the present teachings, and it is to be understood that other embodiments may be used and that changes may be made without departing from the scope of the present teachings. The following description is, therefore, merely illustrative.

It will be understood that when an element such as a layer, region, or substrate is referred to as being “on” or “over” another element, it may be directly on the other element or intervening elements may also be present. In contrast, when an element is referred to as being “directly on” or “directly over” another element, there may be no intervening elements present. It will also be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present.

Reference in the specification to “one embodiment” or “an embodiment” of the present disclosure, as well as other variations thereof, means that a particular feature, structure, characteristic, and so forth described in connection with the embodiment is included in at least one embodiment of the present disclosure. Thus, the phrases “in one embodiment” or “in an embodiment,” as well as any other variations appearing in various places throughout the specification are not necessarily all referring to the same embodiment. It is to be appreciated that the use of any of the following “/,” “and/or,” and “at least one of,” for example, in the cases of “A/B,” “A and/or B” and “at least one of A and B,” is intended to encompass the selection of the first listed option (A) only, or the selection of the second listed option (B) only, or the selection of both options (A and B). As a further example, in the cases of “A, B, and/or C” and “at least one of A, B, and C,” such phrasing is intended to encompass the first listed option (A) only, or the selection of the second listed option (B) only, or the selection of the third listed option (C) only, or the selection of the first and the second listed options (A and B), or the selection of the first and third listed options (A and C) only, or the selection of the second and third listed options (B and C) only, or the selection of all three options (A and B and C). This may be extended, as readily apparent by one of ordinary skill in the art, for as many items listed.

Embodiments of the disclosure include a fiber cable structure, a photonics integrated circuit (PIC) die module including at least one of the fiber cable structures, and a related method. The fiber cable structure includes a foldable fiber optic cable having a first end and a second end. The first end is fixed relative to a cable mount of a PIC die module. An optical connector is on the second end of the foldable fiber optic cable to couple fibers of the foldable fiber optic cable to an optical device. A cable positioner is fixed relative to the cable mount. A coupler is operable to couple the optical connector to the cable positioner with the foldable fiber optic cable including at least one fold therein. The cable positioner and coupler make handling of the PIC die module easier by shortening the length of the fiber optic cable extending from the module and fastening the optical connector relative to the PIC die module. The cable positioner and coupler prevent mechanical damage of the foldable fiber optic cable and/or the PIC die module. The PIC die module is also smaller for handling, storage and/or transport.

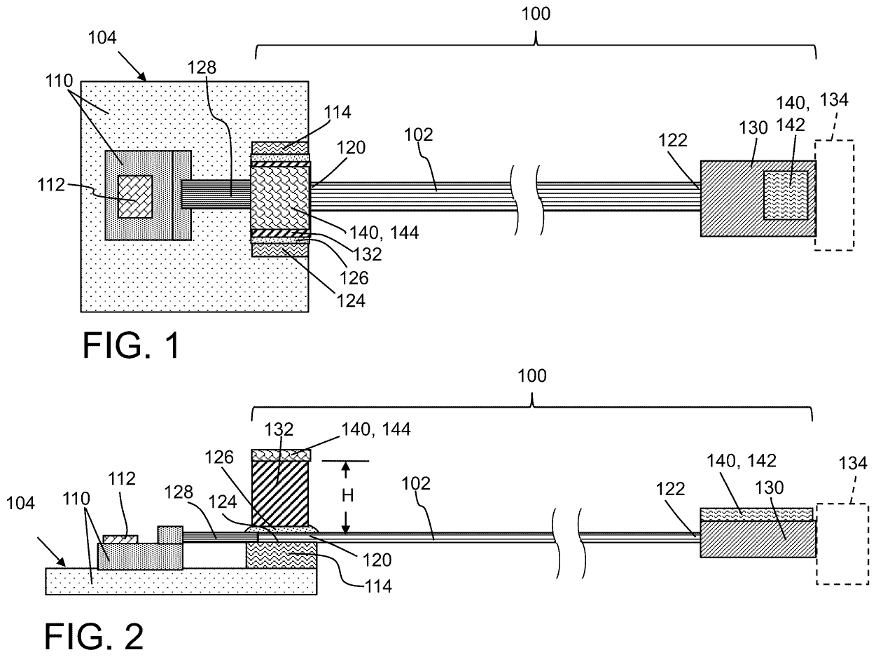

FIG. 1 shows a top-down view and FIG. 2 shows a side view of a fiber cable structure 100 according to embodiments of the disclosure. Fiber cable structure 100 (hereafter “structure 100” for brevity) couples a foldable fiber optic cable 102 (also referred to herein as a flexible fiber optic cable) to a photonics integrated circuit (PIC) die module 104 (hereafter “module 104” for brevity) and may be part of PIC die module 104. Foldable fiber optic cable 102 may include any now known or later developed telecommunications cable including thin flexible strands of glass or plastic (optic fibers) to transmit optical (e.g., light) signals. The strands of the flexible fiber optic cable may include any now known or later developed coverings such as but not limited to: a protective sheath for the strands thereof, e.g., a cladding layer; a coating layer; a strength layer; and an outer jacket. Any number of strands can be used in flexible fiber optic cable 102. Flexible fiber optic cable 102 (hereafter “cable 102” for brevity) has strands therein that are capable of being flexed and/or folded, as will be described herein.

Module 104 may include any now known or later developed photonics integrated circuit board. Module 104 may include a substrate 110, a PIC die 112 on substrate 110, and a cable mount 114. Substrate 110 may include any now known or later developed structures to operatively connect to PIC die 112. For example, substrate 110 may include one or more printed circuit boards, ceramic substrates and/or chip package systems. Substrate 110 also may include any now known or later developed optical signal routing structure such as but not limited to optical waveguides, multiplexors, and optical gratings. PIC die 112 may include any now known or later developed microchip that integrates active electrical circuitry and optical structures to generate, detect and/or manipulate optical signals.

Cable 102 has a first end 120 and a second end 122. First end 120 is configured to couple to cable mount 114 of module 104. Cable mount 114 may include any now known or later developed system to operatively couple first end 120 of cable 102 to substrate 110 and/or PIC die 112. More particularly, cable mount 114 may include a structure to hold cable 102 to module 104. In certain embodiments, cable mount 114 may include a body 124 on substrate 110 and an adhesive 126 configured to adhere cable 102 to module 104. That is, first end 120 of cable 102 may be held to body 124 of cable mount 114 by adhesive 126. Strands 128 of cable 102 may be run into module 104, e.g., part of substrate 110, using any now known or later develop solution, e.g., a cable strand connector including V-grooves to receive each strand, and waveguides to receive optical signals from each strand.

Structure 100 also includes an optical connector 130 on second end 122 of cable 102, and a cable positioner 132 fixed relative to cable mount 114, i.e., adjacent first end 120 of cable 102. Optical connector 130 is operative to couple fibers of cable 102 to an outside optical device 134. Optical connector 130 may include any now known or later developed connector for optically connecting optic fibers of cable 102 to optical device 134, which has a complementary connector. Optical connector 130 may include but is not limited to: a multi-fiber push-on (MPO) connector, a multi-fiber termination (MT) ferrule connector, an angled physical contact (APC) connector, an ultra-physical contact (UPC) connector, and a sub-miniature multi-fiber termination (SM MT) connector. Optical device 134 may include any now known or later developed outside device or network configured to optically interact with module 104, such as but not limited to a light source, an optical telecommunication cable, an optical test unit or a photonics device like another PIC die module. Optical device 134 is shown in dashed form in only FIGS. 1 and 2 for clarity.

Cable positioner 132 may include any structure capable of being fixed to cable mount 114 at or near first end 120 of cable 102. In the example shown in FIGS. 1 and 2, cable positioner 132 includes a block of material coupled to cable mount 114. More particularly, cable positioner 132 may be coupled via adhesive 126 to cable mount 114, e.g., same adhesive that couples first end 120 of cable 102 to cable mount 114. However, cable positioner 132 may be coupled to cable mount 114 or other parts of module 104 using any solution, e.g., fasteners. Alternatively, cable positioner 132 could be formed as part of cable mount 114, e.g., integral with cable mount 114 but raised over adhesive 126, or as an additional structure to a side of substrate 110. Although shown in a particular location, cable positioner 132 can alternatively be located at other locations such as but not limited to: directly on body 124 of cable mount 114, or on substrate 110, e.g., printed circuit board. As will be described further herein, cable positioner 132 has a size configured to position cable 102 with at least one fold at a predefined radius of curvature.

In the drawings, body 124 of cable mount 114, adhesive 126, cable positioner 132 and optical connector 130 may be shown in the top-down drawings (e.g., FIG. 1) as having their ends and/or edges as non-overlapping for illustrations purposes. It is emphasized that in reality that some or all of the ends and/or edges of the listed structures may be hidden by one or more structures thereover and, hence, may not be viewable in a top-down view.

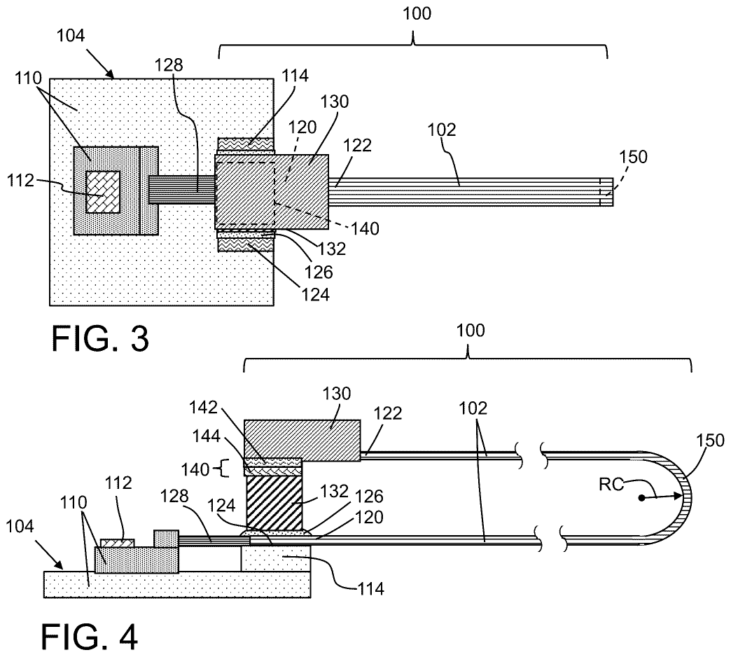

Structure 100 also includes a coupler 140 operable to couple optical connector 130 to cable positioner 132 with cable 102 including at least one fold therein. FIG. 3 shows a top-down view and FIG. 4 shows a side view of optical connector 130 operable to couple to cable positioner 132 with cable 102 including at least one fold 150 therein. (Note, FIG. 4 is slightly enlarged compared to FIG. 3). Coupler 140 includes a first coupling element 142 and a second coupling element 144. More particularly, coupler 140 includes first coupling element 142 fixed relative to one of cable positioner 132 and optical connector 130 and second coupling element 144 fixed relative to the other of cable positioner 132 and optical connector 130. First and second coupling elements 142, 144 are configured to selectively couple together. For purposes of description, optical connector 130 may be shown including first coupling element 142 of coupler 140 thereon, and cable positioner 132 may be shown including second coupling element 144 of coupler 140. As will be recognized, the positions of the parts of coupler 140 may be switched without departing from the teachings of the disclosure.

First and second coupling elements 142, 144 may include any structure configured to selectively couple optical connector 130 to cable positioner 132 with cable 102 including at least one fold 150 therein. In this manner, cable 102 is shortened from its normal length, and securely fastened to module 104 to reduce and/or prevent any possible damage to cable 102 and/or module 104 during handling. In the examples shown, second coupling element 144 is configured to couple to first coupling element 142 of coupler 140, and vice versa, to operatively couple optical connector 130 to cable positioner 132 with cable 102 including at least one fold 150 therein.

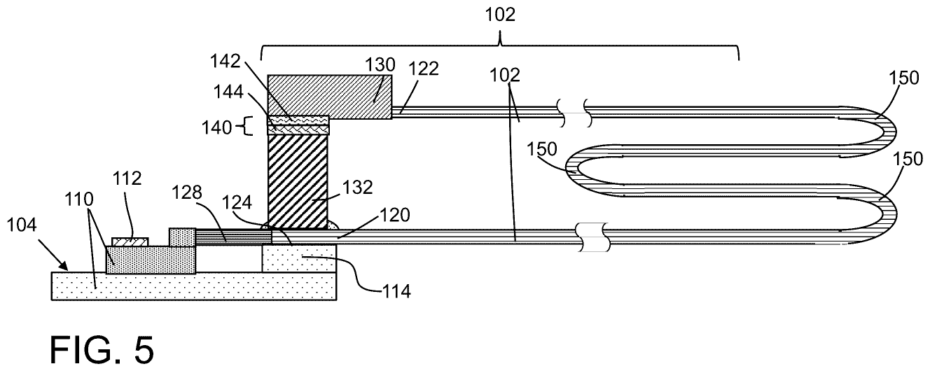

FIGS. 3 and 4 show only one (1) fold 150 in cable 102. FIG. 5 shows a side view of structure 100 including more than one fold 150, e.g., three folds. Other numbers of fold 150 may also be possible depending on, for example, the length of cable 102 between its first and second ends 120, 122. The number, nature and configuration of fold(s) 150 may vary depending on characteristics of cable 102 used, such as but not limited to: type of cable, strand material (e.g., glass, plastic, etc.), overall cross-dimensional size, length, diameter of strands, number of strands, and/or layout (flat, round, etc.). As used herein, “fold” or “folds” may include bends, draping, coiling and/or any form of re-arrangement of cable 102 to shorten its length. In certain embodiments, fold(s) 150 may have a predefined radius of curvature RC. The predefined radius of curvature RC may be defined as a minimum radius of curvature that prevents damage to cable 102, i.e., strands therein. In one non-limited example, cable 102 may have a minimum radius of curvature in a range of 5.0 to 7.5 micrometers. Other minimum radius of curvature may be possible for other configurations of cable 102. Cable positioner 132 may have a size, e.g., height H (FIG. 2) relative to cable mount 114 and, more particularly, first end 120 of cable 102, configured to, perhaps with a thickness of coupler 140, position cable 102 with fold(s) 150 at the predefined radius of curvature RC. In this manner, cable positioner 132 positions cable with fold 150 in a manner to prevent damage to cable 102 and/or module 104 while cable 102 is coupled to module 104.

Coupler 140 can take a variety of forms. In FIGS. 1-4, 13 and 14, coupler 140 is shown (schematically) including a hook-and-loop fastener. In this example, first coupling element 142 includes one of a hook portion and a loop portion of the hook-and-loop fastener and second coupling element 144 includes the other of the hook portion and the loop portion of the hook-and-loop fastener. The portions of the hook-and-loop fastener may be coupled to cable positioner 132 and optical connector 130 in any now known or later developed fashion such as but not limited to adhesive and threaded fasteners. The location of the hook portion and the loop portion can be switched from that shown.

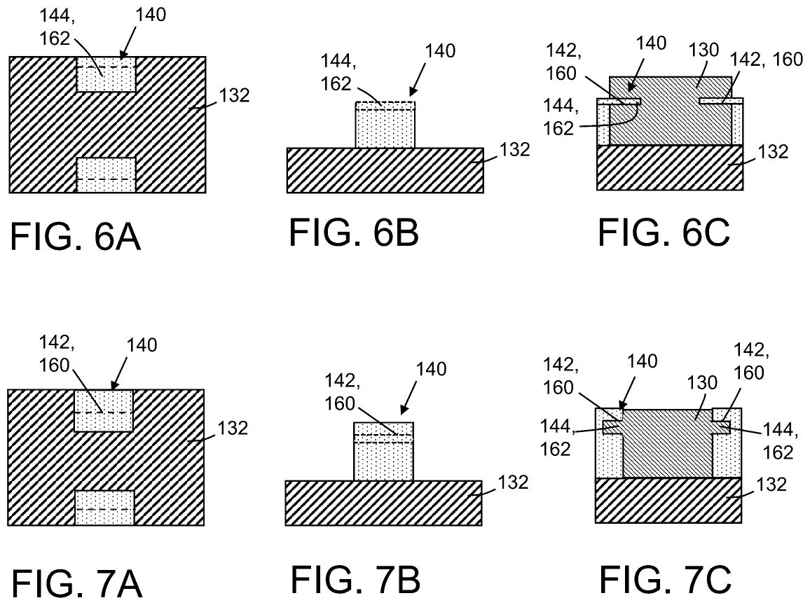

FIGS. 6A-C show a top-down view, a side view and an end view of parts of coupler 140, cable positioner 132 and/or optical connector 130, respectively, according to other embodiments. In this example, first coupling element 142 includes a slot 160 and second coupling element 144 includes an engagement element 162 configured to be selectively held by slot 160. More particularly, as shown in FIGS. 6A-C, first coupling element 142 may include slot 160 defined in optical connector 130 and second coupling element 144 includes engagement element 162 on cable positioner 132. FIGS. 7A-C show a top-down view, a side view and an end view of parts of coupler 140, cable positioner 132 and/or optical connector 130, respectively, in a reverse arrangement of coupling elements 142, 144 as in FIGS. 6A-C. In this example, first coupling element 142 includes slot 160 defined in cable positioner 132 and second coupling element 144 includes engagement element 162 on optical connector 130. Regardless of arrangement, optical connector 130 may be manually manipulated to insert engagement element 162 into slot 160 to hold optical connector 130 to cable positioner 132 with cable 102 having fold(s) 150 (FIGS. 3-5) therein. Slot 160 and engagement element 162 may optionally include any mechanism to retain the coupling, e.g., detents, interference fit, etc.

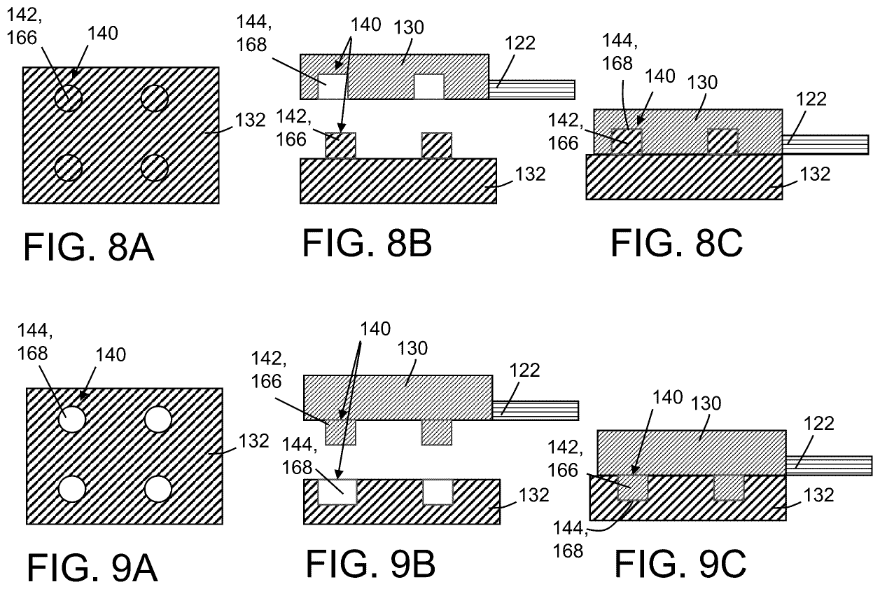

FIGS. 8A-C show a top-down view, a side view and an end view of parts of coupler 140, cable positioner 132 and/or optical connector 130, respectively, according to other embodiments. In certain embodiments, as shown in FIGS. 8A-C, coupler 140 includes a stud-and-tube fastener with first coupling element 142 including a stud portion 166 of the stud-and-tube fastener and second coupling element 144 including a tube portion 168 of the stud-and-tube fastener. In certain embodiments, as shown in FIGS. 8A-C, first coupling element 142 includes stud portion 166 of the stud-and-tube fastener on cable positioner 132 and second coupling element 144 includes tube portion 168 of the stud-and-tube fastener on optical connector 130. FIGS. 9A-C show a top-down view, a side view and an end view of parts of coupler 140, cable positioner 132 and/or optical connector 130, respectively, in the reverse arrangement from that shown in FIGS. 8A-C. Here, first coupling element 142 includes stud portion 166 of the stud-and-tube fastener on optical connector 130 and second coupling element 144 includes tube portion 168 of the stud-and-tube fastener on cable positioner 132. Regardless of arrangement, optical connector 130 may be manipulated to manually engage stud portions 166 and tube portions 168 to hold optical connector 130 to cable positioner 132 with cable 102 having fold(s) 150 therein. The portions 166, 168 of the stud-and-tube fastener may include any mechanism to retain the coupling, e.g., detents, interference fit, etc. While a particular arrangement of stud-and-tube fastener is illustrated, it will be recognized that this type coupler can take a wide variety of alternative forms of interlocking blocks.

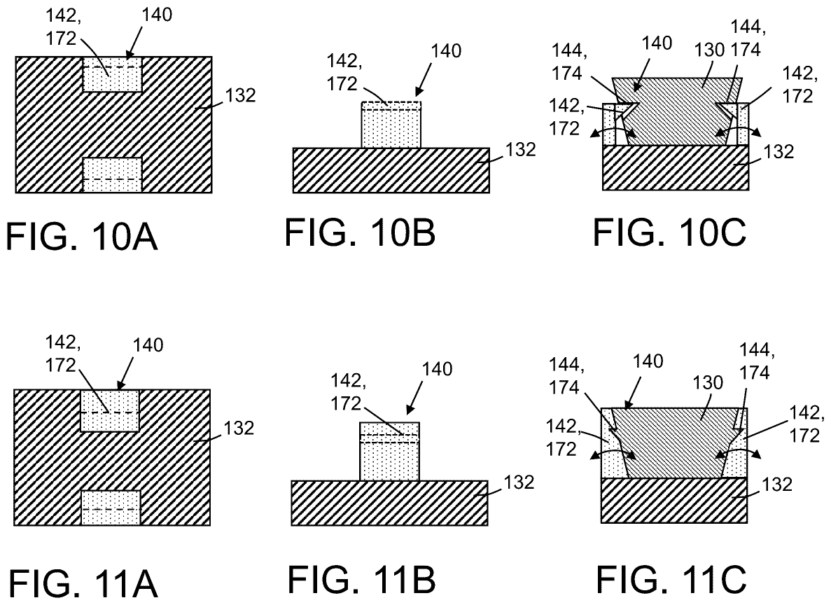

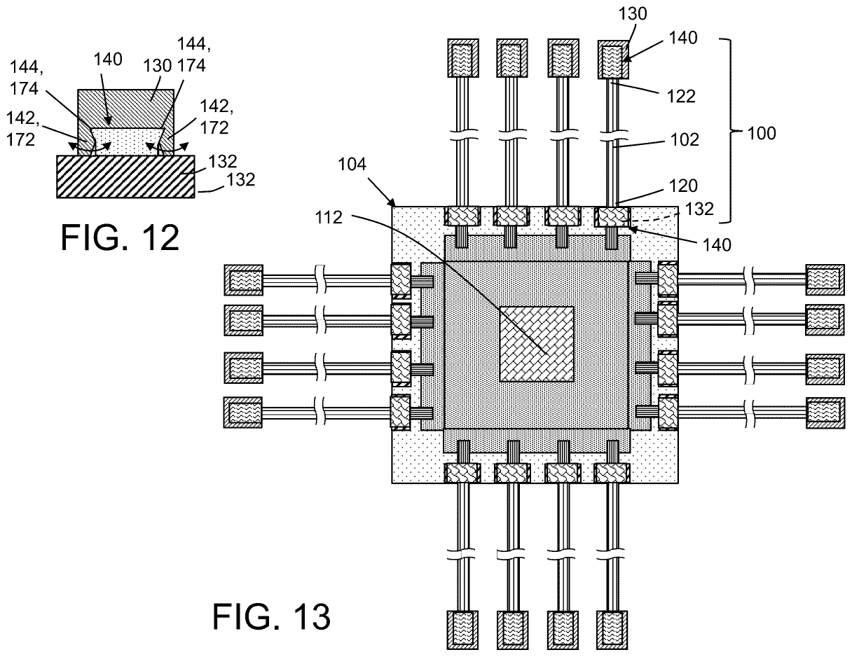

FIGS. 10A-C show a top-down view, a side view and an end view of parts of coupler 140, cable positioner 132 and/or optical connector 130, respectively, according to yet other embodiments. In certain embodiments, as shown in FIGS. 10A-C, coupler 140 includes a spring clip arrangement with first coupling element 142 including a spring clip 172 and second coupling element 144 including a spring clip engagement element 174. Spring clip engagement element 174 selectively engages and is held by spring clip 172, i.e., to hold optical connector 130 to cable positioner 132 with cable 102 having fold(s) 150 therein. In certain embodiments, as shown in FIGS. 10A-C, first coupling element 142 includes spring clip 172 on cable positioner 132 and second coupling element 144 includes spring clip engagement element 174 on optical connector 130. In FIGS. 10A-C, spring clip engagement element 174 includes an opening in optical connector 130 in which spring clip 172 engages; however, other forms of engagement elements may be used. FIGS. 11A-C show a top-down view, a side view and an end view of parts of coupler 140, cable positioner 132 and/or optical connector 130, respectively, in the different arrangement from that shown in FIGS. 10A-C. Here, spring clip engagement element 174 includes projection(s) on optical connector 130 that engage in opening(s) in spring clip 172. FIG. 12 shows an end view of parts of coupler 140, cable positioner 132 and/or optical connector 130, respectively, according to additional embodiments. Here, first coupling element 142 includes spring clip 172 on optical connector 130 and second coupling element 144 includes spring clip engagement element 174 on cable positioner 132. Regardless of arrangement, optical connector 130 may be manually manipulated to have spring clip engagement element 174 and spring clip 172 engage one another to hold optical connector 130 to cable positioner 132 with cable 102 having fold(s) 150 therein. Generally, spring clip 172 expands to receive spring clip engagement element 174, and then returns to its initial position to grasp spring clip engagement element 174. While particular example arrangements of spring clips 172 and spring clip engagement elements 174 are illustrated, it will be recognized that this type coupler can take a wide variety of alternative forms.

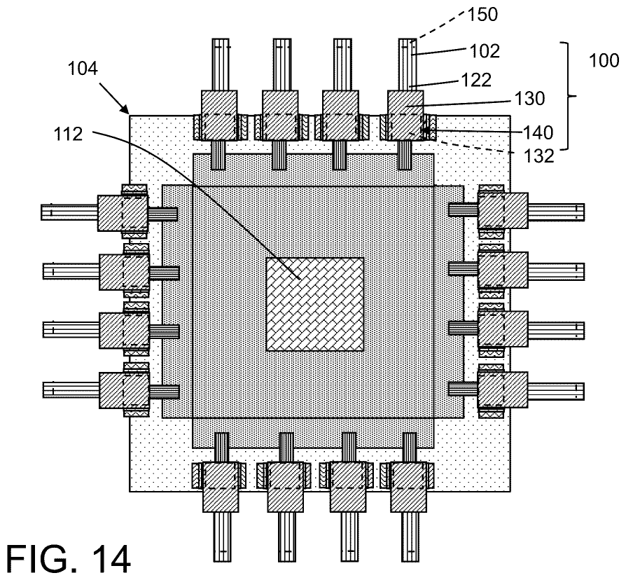

Embodiments of the disclosure also include a photonics integrated circuit (PIC) die module 104 including substrate 110, PIC die 112 on substrate 110, and at least one of structures 100, as described herein. FIGS. 13 and 14 show top-down views of modules 104 including more than one structure 100 according to embodiments of the disclosure. Only one structure 100 is labeled in each figure to ensure clarity of illustration. FIG. 13 shows a module 104 with optical connectors 130 extending away from cable positioners 132, i.e., with first and second ends 120, 122 of cable 102 separated. FIG. 14 shows a module 104 with optical connectors 130 coupled relative to cable positioners 132, i.e., with first and second ends 120, 122 of each cable 102 adjacent one another and fold(s) 150 within each cable 102. While four structures 100 are shown on each side of module 104 in FIGS. 13 and 14, any number of structures 100 can be employed on each side. FIGS. 13 and 14 show coupler 140 in the form illustrated in FIGS. 1-4; however, any form of coupler 140 described herein can be used where more than one structure 100 on a given module 104 is employed. In addition, different couplers 140, as described herein, can be used for different cables 102 on a given module 104, e.g., with coupler 140 as in FIGS. 1-4 used on one or more cables 102 and coupler 140 as in FIGS. 6A-C used on other cables 102.

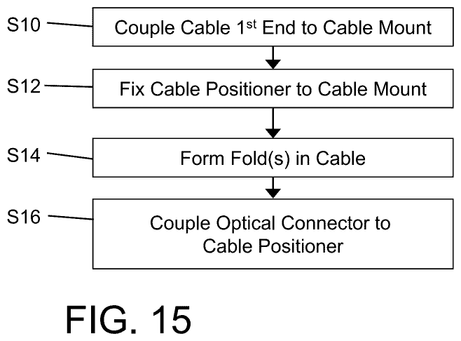

A method according to embodiments of the disclosure will now be described relative to the flow diagram of FIG. 15. The method may include, in process S10 and as shown in FIGS. 1-2, coupling first end 120 of cable 102 having first end 120 and second end 122 to cable mount 114 of module 104, e.g., using adhesive 126 or other fasteners, as described herein. As noted, cable 102 includes optical connector 130 on second end 122 of cable 102 and optical connector 130 is configured to couple fibers of cable 102 to optical device 134. The method also includes, in process S12 and as shown in FIGS. 1-2, fixing cable positioner 132 relative to cable mount 114, as described herein. Process S14, as shown for example in FIGS. 3 and 5, includes forming at least one fold 150 in cable 102. Fold(s) 150 may be made by manually bending cable 102 over itself at least once, bringing optical connector 130 closer to cable positioner 132. Process S16 includes, as shown in FIGS. 3-5, 6-11 (C versions), 12 and 14, coupling optical connector 130 to cable positioner 132 using coupler 140. As noted, coupler 140 includes first coupling element 142 fixed relative to one of cable positioner 132 and optical connector 130 and second coupling element 144 fixed relative to the other of cable positioner 132 and optical connector 130. As noted, first and second coupling elements 142, 144 are configured to selectively couple together. The coupling may include moving optical connector 130 to couple to cable positioner 132 using any form of coupler 140 described herein. As note, cable positioner 132 has a size (perhaps with coupler 140) that prevents fold 150 from damaging cable 102 by maintaining a predefined radius of curvature RC (FIG. 5).

Embodiments of the disclosure provide various technical and commercial advantages, examples of which are discussed herein. The structure including the cable positioner and the coupler make handling of the PIC die module easier by shortening the length of the fiber optic cable extending from the module and fastening the optical connector relative to the module. The cable positioner and coupler prevent mechanical damage of the foldable fiber optic cable and/or the PIC die module. The PIC die module is also made smaller for handling, storage and/or transport using the structure described herein.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A fiber cable structure, comprising:
a foldable fiber optic cable having a first end and a second end, wherein the first end is fixed relative to a cable mount of a photonics integrated circuit (PIC) die module;
an optical connector on the second end of the foldable fiber optic cable to couple fibers of the foldable fiber optic cable to an optical device;
a cable positioner fixed relative to the cable mount; and
a coupler operable to couple the optical connector to the cable positioner with the foldable fiber optic cable including at least one fold therein.

2. The fiber cable structure of claim 1, wherein the coupler includes a first coupling element fixed relative to one of the cable positioner and the optical connector and a second coupling element fixed relative to the other of the cable positioner and the optical connector, wherein the first and second coupling elements are configured to selectively couple together.

3. The fiber cable structure of claim 2, wherein the first coupling element includes a slot and the second coupling element includes an engagement element, wherein the engagement element is configured to be selectively held by the slot.

4. The fiber cable structure of claim 2, wherein the first coupling element includes one of a hook portion and a loop portion of a hook-and-loop fastener and the second coupling element includes the other of the hook portion and the loop portion of the hook-and-loop fastener.

5. The fiber cable structure of claim 2, wherein the first coupling element includes a stud portion of a stud-and-tube fastener and the second coupling element includes a tube portion of the stud-and-tube fastener.

6. The fiber cable structure of claim 2, wherein the first coupling element includes a spring clip and the second coupling element includes a spring clip engagement element, wherein the spring clip engagement element selectively engages and is held by the spring clip.

7. The fiber cable structure of claim 1, wherein the cable positioner has a size configured to position the foldable fiber optic cable with the at least one fold at a predefined radius of curvature.

8. The fiber cable structure of claim 1, wherein the first end of the foldable fiber optic cable is held to the cable mount by an adhesive.

9. The fiber cable structure of claim 1, wherein the optical connector includes one of a multi-fiber push-on (MPO) connector, a multi-fiber termination (MT) ferrule connector, an angled physical contact (APC) connector, an ultra-physical contact (UPC) connector, and a sub-miniature multi-fiber termination (SM MT) connector.

10. The fiber cable structure of claim 1, wherein the PIC die module includes a substrate, a PIC die on the substrate, and the cable mount, wherein the cable mount is configured to operatively couple the first end of the foldable fiber optic cable to the PIC die.

11. A photonics integrated circuit (PIC) die module, comprising:
a substrate;
a PIC die on the substrate; and
at least one of the following:
a foldable fiber optic cable having a first end and a second end, wherein the first end is fixed relative to a cable mount of a photonics integrated circuit (PIC) die module;
an optical connector on the second end of the foldable fiber optic cable to couple fibers of the foldable fiber optic cable to an optical device;
a cable positioner fixed relative to the cable mount; and
a coupler operable to couple the optical connector to the cable positioner with the foldable fiber optic cable including at least one fold therein.

12. The PIC die module of claim 11, wherein the coupler includes a first coupling element fixed relative to one of the cable positioner and the optical connector and a second coupling element fixed relative to the other of the cable positioner and the optical connector, wherein the first and second coupling elements are configured to selectively couple together.

13. The PIC die module of claim 12, wherein the first coupling element includes a slot and the second coupling element includes an engagement element, wherein the engagement element is configured to be selectively held by the slot.

14. The PIC die module of claim 12, wherein the first coupling element includes one of a hook portion and a loop portion of a hook-and-loop fastener and the second coupling element includes the other of the hook portion and the loop portion of the hook-and-loop fastener.

15. The PIC die module of claim 12, wherein the first coupling element includes a stud portion of a stud-and-tube fastener and the second coupling element includes a tube portion of the stud-and-tube fastener.

16. The PIC die module of claim 12, wherein the first coupling element includes a spring clip and the second coupling element includes a spring clip engagement element, wherein the spring clip engagement element selectively engages and is held by the spring clip.

17. The PIC die module of claim 11, wherein the cable positioner has a size configured to position the foldable fiber optic cable with the at least one fold at a predefined radius of curvature.

18. The PIC die module of claim 11, wherein the first end of the foldable fiber optic cable is held to the cable mount by an adhesive.

19. The PIC die module of claim 11, wherein the optical connector includes one of a multi-fiber push-on (MPO) connector, a multi-fiber termination (MT) ferrule connector, an angled physical contact (APC) connector, an ultra-physical contact (UPC) connector, and a sub-miniature multi-fiber termination (SM MT) connector.

20. A method, comprising:
coupling a first end of a foldable fiber optic cable having the first end and a second end to a cable mount of a photonics integrated circuit (PIC) die module, wherein the foldable fiber optic cable includes an optical connector on the second end of the foldable fiber optic cable configured to couple fibers of the foldable fiber optic cable to an optical device;
fixing a cable positioner relative to the cable mount;
forming at least one fold in the foldable fiber optic cable; and
coupling the optical connector to the cable positioner using a coupler including a first coupling element fixed relative to one of the cable positioner and the optical connector and a second coupling element fixed relative to the other of the cable positioner and the optical connector, wherein the first and second coupling elements are configured to couple together.
